(19) United States
(12) Patent Application Publication
(10) Pub. No.: US 2012/0233076 A1
(43) Pub. Date: Sep. 13, 2012

(54) REDEEMING OFFERS OF DIGITAL CONTENT ITEMS

(75) Inventors: Gareth P. J. Sutcliffe, London (GB); Jeremie A. H. Texier, Farnham (GB); John Clavin, Seattle, WA (US)

(73) Assignee: MICROSOFT CORPORATION, Redmond, WA (US)

(21) Appl. No.: 13/043,337

(22) Filed: Mar. 8, 2011

(51) Int. Cl. G06Q 30/00; H04L 9/30

(52) U.S. Cl. 705/50; 705/14.26

(57) ABSTRACT

The technology provides for redeeming an offer of a digital content item based on identifying a physical object in image data and verifying a unique identifier associated with the physical object. The unique identifier may be recognized from the physical object by a computer system in image data from a camera. The unique identifier is typically attached to or part of the physical object. For example, the unique identifier may be a graphic design integral to a physical object like an article of clothing, jewelry or a book cover. Furthermore, a user may be identified as being associated with the physical object. In some examples, the user having bodily contact with, for example wearing or holding, the physical object is deemed the user associated with the physical object for redemption of the digital content item.

### BACKGROUND

Multimedia content providers and third party licensees often partner to promote each other's products and services. A code may be provided with a non-digital product provided by a licensee or the multimedia content provider itself. The user may type the code into a website or software application to retrieve an item like a video to watch, or a game element or other digital content. In many circumstances, a user can enter the code and retrieve the promotional item without any indication of possession or ownership of a real world product from which the code was retrieved other than the entry of the code.

### SUMMARY

The technology provides for redeeming an offer of a digital content item based on receiving a valid unique identifier. Additionally, the redemption may also be based on identifying in image data a physical object associated with the unique identifier. In some examples, a user is identified as being associated with the physical object. The unique identifier may also be identified from the physical object in image data in some examples.

In one embodiment, the technology provides a computer-implemented method of redeeming an offer of a digital content item. A physical object is identified in image data, and a unique identifier associated with the physical object is received. The method further comprises verifying whether the unique identifier is valid for redeeming the digital content item. Responsive to the unique identifier being valid, executing software provides the digital content item. Some examples of providing the digital content item are displaying or playing video of the digital content item, playing audio of the digital content item or executing code of the digital content item.

In another embodiment, the technology provides a computer-implemented system for redeeming an offer of a digital content item. The system comprises an image capture device for capturing image data of a physical object including a unique identifier and image data of a user associated with the physical object. One or more processors communicate with the image capture device for receiving the image data of the physical object and for identifying the user associated with the physical object from the image data. The one or more processors receive and verify the unique identifier. Responsive to verification of the unique identifier, the one or more processors provide the digital content item to a virtual representation associated with the identified user. An example of a virtual representation is an avatar or character the user controls in the application.

In another embodiment of the technology, one or more processor-readable storage media have instructions encoded thereon which instructions cause one or more processors to execute a method for redeeming an offer of a digital content item. The method comprises identifying a physical object in image data and receiving a unique identifier associated with the physical object. In some examples, receiving a unique identifier comprises identifying the unique identifier from image data of the physical object. The method further comprises verifying whether the unique identifier is valid for redeeming the digital content item. Responsive to the unique identifier being valid, the digital content item is provided by executing software. Redemption data for the offer of the digital content item is updated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates some examples of physical objects and unique identifier formats which may be used in embodiments of the technology.

FIG. 2A illustrates a flowchart of an embodiment of a method for producing redeemable digital content items and software for redeeming them.

FIG. 2B illustrates a flowchart of an embodiment of a method for providing objects with unique identifiers for redeeming the offers of digital content items.

FIG. 3 illustrates an example embodiment of a target recognition, analysis, and tracking system in which embodiments of the technology can operate.

FIG. 4 illustrates an example of a user in bodily contact with an object including a unique identifier in a camera field of view.

FIG. 5 illustrates one embodiment of a system for redeeming an offer of a digital content item.

FIG. 6 illustrates another embodiment of a system for redeeming an offer of a digital content item operating within a network of computers.

FIG. 7 illustrates an embodiment of a system from a software perspective for redeeming an offer of a digital content item.

FIG. 8 illustrates an example of a data set for a unique identifier.

FIG. 9 is a flowchart of an embodiment of a method for redeeming an offer of a digital content item.

FIG. 9A is a flowchart of an example of the method embodiment of FIG. 9.

FIG. 10 is a flowchart illustrating an embodiment of a method and criteria examples for verifying a unique identifier.

FIG. 11 is a flowchart illustrating an embodiment of a method for registering a user for receiving the digital content item associated with a unique identifier.

FIG. 12 illustrates an example of a computing system that may be used to implement one or more embodiments of the technology.

FIG. 13 illustrates an example of a general purpose computing system which may be used to implement one or more computer systems used in implementing one or more embodiments of the technology.

FIG. 14 depicts an example block diagram of a mobile device in which embodiments of the technology may operate.

### DETAILED DESCRIPTION

The technology provides for redeeming an offer of a digital content item based on a valid unique identifier associated with a physical object. In one embodiment, from image data, the physical object is identified, and the unique identifier is identified from the physical object. A user who may be holding, wearing, or otherwise have bodily contact with the physical object is identified. Through possession or ownership of a real world physical object, the user can access the digital content item. In other embodiments, possession or ownership of an electronic content item which includes a unique identifier may be outputted, e.g. visually displayed or audibly output, by a physical computing device object.

Multimedia applications which generate multimedia content are an example of software which when executing provides a digital content item. In many examples, a digital content item includes multimedia content. Multimedia content may include any type of audio, video, and/or image content. Some examples of multimedia content are television content, music, movies, video clips, audio clips, and interactive games.

The unique identifier when redeemed provides, for example unlocks, an item of digital content, typically represented in video, image data, audio or a combination of these. An example of such a digital content item is a game related item such as a unique weapon, audio data, for example a song, a video, one or more special effects, a skill like being able to jump twenty feet, perform a somersault or speak a language, a power like invisibility or seeing through walls, game points, game or virtual money, a tattoo or other insignia, or an article of clothing, an outfit, or jewelry for a user's avatar. Other items may be a new character or avatar, a pet, a vehicle, a tool and a machine, which may produce physical objects like bullets, magical objects or an abstract thing like time. The digital content item may also be a game hint or other strategic advantage like a map. In some instances, the digital content item is an interactive sequence like another level of play, a game add-on, or another setting or environment to play another interactive sequence. In other non-game multimedia applications, some examples of the digital content item may be additional informational content, an interactive sequence, or an interactive software application. For example, an interactive software application may allow a user to virtually try on costumes from a movie, to virtually ride an animal from the movie or to virtually participate in an action sequence like navigating a spaceship or driving a car in a car chase. As the examples above illustrate downloadable content may be a digital content item. A key to unlock content or access downloaded content may also be the digital content item.

Some examples of a physical object from which a unique identifier may be identified are packaging for an object, an article of clothing including footwear, a piece of jewelry, a book, a toy, a card, some examples of which are a postcard, a playing card, a greeting card, other types of paper products, a key ring, a sporting good, a removable storage media some examples of which are a compact disc (CD), a DVD or a memory stick, and a computing device, both general purpose and specialized like a music player (e.g. MP3 player).

Electronic value may be added to a licensed real world or electronic object. In the case of business partnerships, the redemption of the unique identifier allows a gaming or other multimedia application provider to track the redemption rate of the digital content item independently from the partner providing the licensed objects including the unique identifiers. Furthermore, the success of the licensed objects can be effectively tracked. Moreover, the sale of game or other multimedia applications to those redeeming the content can be effectively tracked.

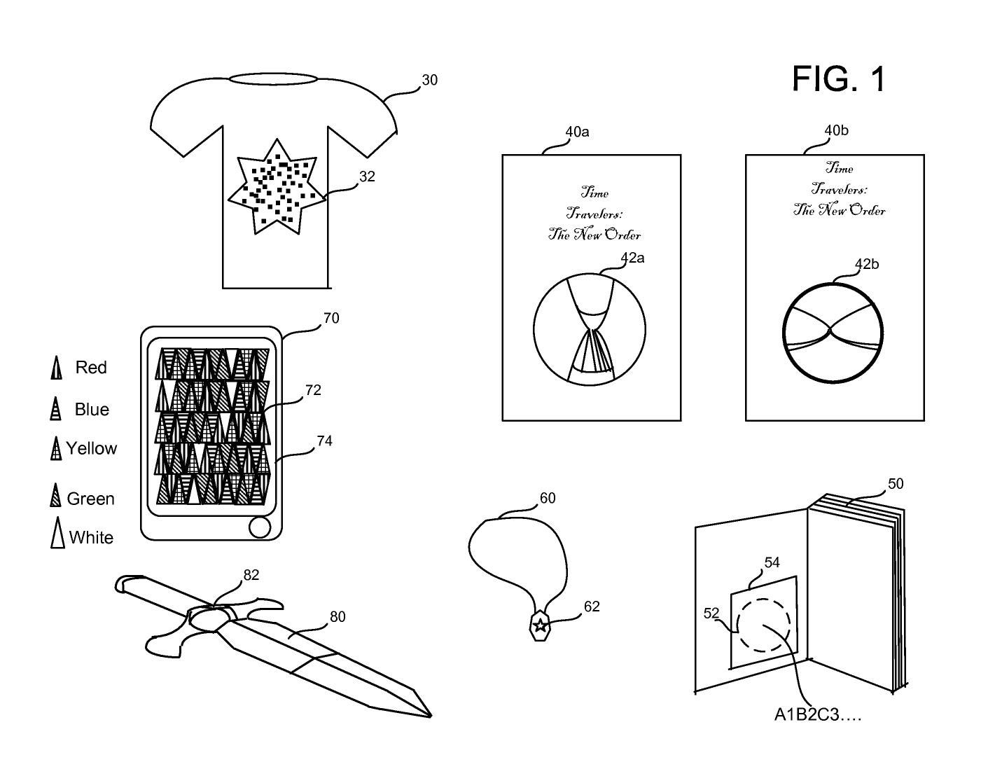

FIG. 1 illustrates some examples of physical objects and unique identifier formats which may be used in embodiments of the technology. In one example, an article of clothing is illustrated as a T-Shirt 30 and includes a graphic design 32 of a seven point star with a mobile tag. Mobile tags may employ two dimensional bar code patterns which are capable of representing unique identifiers for redeeming digital content items.

Versions 40a and 40b of the cover of a real world or physical book with paper pages are illustrated with different versions 42a, 42b of a graphic design. For illustrative purposes, the book cover includes a fictional title “The New Order” for a fictional game “Time Travelers.” The graphic design example includes an hour glass with sand in a circle. Several characteristics of the graphic design may be changed in each version to create unique identifiers. In this example, the circle in the graphic design 42b has a smaller size than the circle in 42a. The line of the circle of the 42b design is thicker. The orientation of the hour glass symbol is a number of degrees, about 90 in this example, off from the orientation of the hour glass in the graphic design 42a on the other cover version 40a. In other examples, the line width of the hour glass may be varied as well. Additionally, the amount of sand in the top and bottom of the hour glass can be varied so a fullness level may also be used to make designs unique. Furthermore, the shape of the sand in either half of the hour glass may be modified to distinguish the graphic designs. In other examples, the color of the sand may be varied as well as other color patterns or schemes on the cover 40 like the combination of colors on the cover overall and the background to the hourglass. Furthermore, the size of the letters in the title may be varied. The font for the title and other text may also be varied.

As illustrated by the example of the cover versions 40a and 40b, various characteristics of a graphic design may be used to make unique identifiers. Some examples are a color scheme or color pattern, size, orientation, shape, and font. Other characteristics include one or more symbols and an arrangement of one or more symbols. For example, mobile tags like the mobile tag 32 on the T-Shirt 30 uses an arrangement of black shapes on white, black squares in this example of a two dimensional bar code, to represent a unique identifier.

The physical book 50 is another example of a physical object. Inside its front cover is an enclosure, for example, a sealed packet 54, which encloses a unique identifier 52 to secure it from being used by a someone trying to simply copy the code without purchasing the book. In this example, the unique identifier 52 is an alphanumeric code, e.g. A1B2C3 . . . . Other unique codes of letters, of numbers or both may be used. An enclosure which is intact indicates to a potential purchaser that the code has not been copied and used already. When he purchases the book, he can open the enclosure and use the code as the unique identifier to redeem the content.

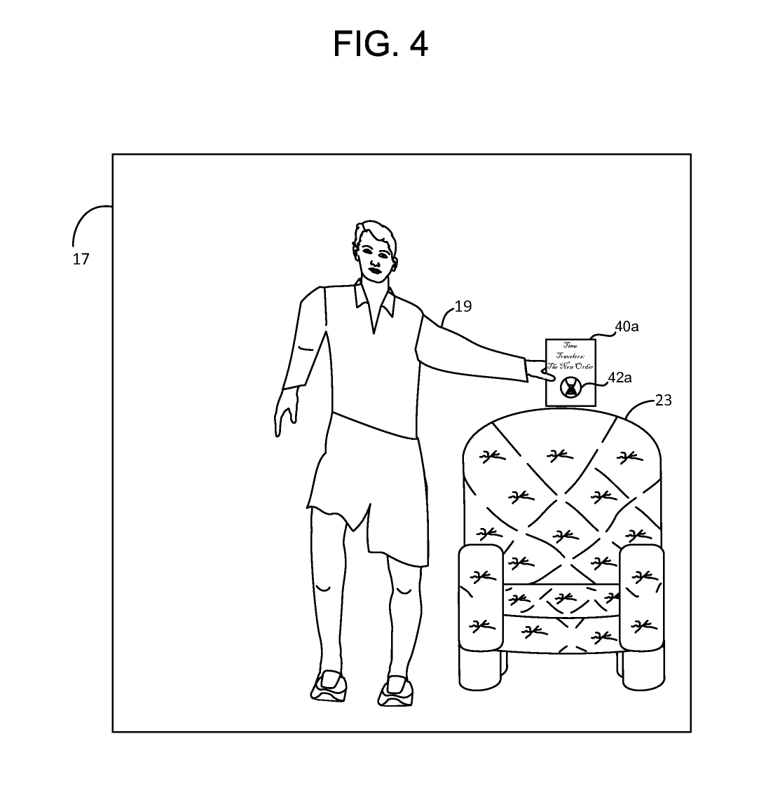

The tablet computer 70 illustrates another example on its display 74 of a unique identifier 72 represented by an arrangement of symbols, triangles in this example, in a unique color pattern. The arrangement or pattern is an example of a high capacity color bar code. In this example, red, blue, yellow, green and white make up the pattern colors. The user may have purchased an electronic content item such as an e-book version of “Time Travelers: The New Order.” The e-book includes the high capacity color bar code in its data as the unique identifier, so the user can access the weapon or other promotional item offered in the Time Travelers game. Like holding a copy of the physical book 40, the user can hold or touch her tablet, e-reader, smartphone, laptop, or other computing device displaying the unique identifier in front of a camera (See discussion of FIG. 4 below) so the digital content item is associated with her. The camera may capture this displayed unique identifier from the computing device object just like from any other physical object. In some embodiments, the unique identifier can be transmitted in a computer readable data format other than image data from a computing device to a game console or other computing system executing software which redeems the offer of the item. Image data of the user holding the computing device may still be used to associate the redeemed item with the user.

The necklace 60 is another example of a physical object in this case, jewelry, including a unique identifier. A graphic design 62 again may be used as the unique identifier. In other examples, a unique identifier may be received in one or more frequencies outside the visible range. In other examples, an infrared data tag 62 may be embodied in the jewelry to include a unique identifier which may be detected and read by an infrared signal. In other examples, a radio frequency identifier (RFID) 62 may be included in the jewelry which an RFID sensor or reader of a computing device may detect and convert to a computer readable format. The sword 80 is another example of a physical object as a toy including a unique identifier 82 such as a graphic design, an infrared tag or an RFID tag.

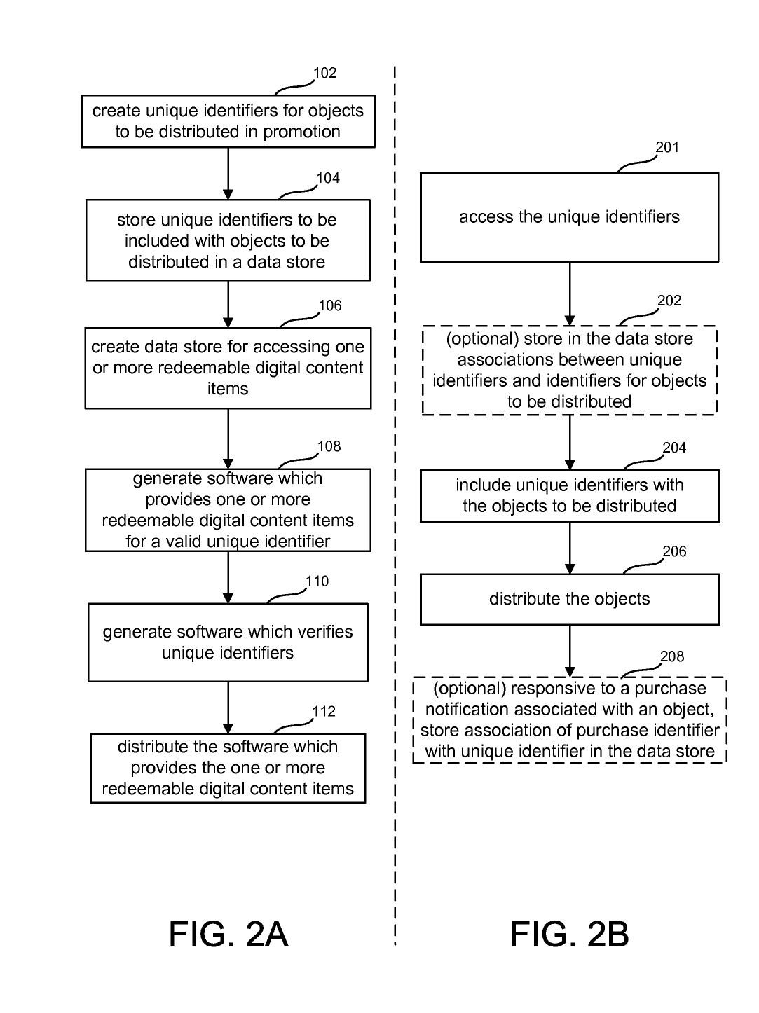

FIG. 2A illustrates a flowchart of an embodiment of a method for producing redeemable digital content items and software for redeeming them. A software developer of a multimedia application or a gaming or multimedia service which is being promoted with the objects including the unique identifiers creates in step 102 unique identifiers for the objects to be distributed in the promotion. The unique identifiers may be for electronic content which can be output by a physical computing device or for physical objects themselves.

As an illustrative example, the seller of books being promoted may give a number of objects to be marked, and the software developer uses a known technique to generate that number of unique identifiers for a 1:1 correspondence between unique identifiers and objects. In step 104, the unique identifiers being created are being stored in a data store.

In step 106, a data store for accessing one or more redeemable content items is created. Depending on what type of application is being promoted, for example a multimedia application or a gaming service, the publisher of the multimedia application or the service entity may provide at least one digital content item. A data set for a digital content item may include data, code or both for generating the item.

In step 108, software is generated which provides one or more redeemable digital content items for a valid unique identifier. The software embodies logic for receiving an identifier, perhaps for identifying it from image data of the physical object, and requesting verification of the received identifier. Once the received identifier is verified, the software may play a video or audio content item or load the code, which may be embodied in software or firmware, of the digital content item for execution by a processor. For example, the software may add instructions for adding points or virtual money to a user associated with a parameter which is filled at redemption. The software may add another image file for the item such as a weapon or tattoo. In other examples, the software may provide instructions to implement actions or special effects associated with a power or skill for execution by a virtual representation of a user. In other examples, the software may execute a video file, an audio file or an interactive application related to the multimedia application as the redeemable digital content item.

In step 110, software which verifies a received identifier is generated. In some examples, this may be software accessed on a server by remote executing applications and in other examples, this software may be part of the software which provides the one or more redeemable digital content items. For example, the a multimedia application may send the unique identifier or a data item derived from it to another computer system over the Internet. The other computer system may do a comparison with identifiers stored in a data store or other type of verification test to validate the received identifier and send a validation notification to the executing multimedia application. In some examples, the multimedia application is updated to perform the verification itself.

In step 112, the software which provides the one or more redeemable digital content items is distributed. In some examples, the unique identifiers and verification may be provided by a platform or service like a movie distribution site or a gaming service, and the software which provides the redeemed content by a publisher of multimedia content like a movie distributed by the site or a game which can execute within the platform of the gaming service, e.g. XBOX® Live.

FIG. 2B illustrates a flowchart of an embodiment of a method for providing objects with unique identifiers for redeeming the offers of digital content items. The promoter of the physical object or electronic content outputted by a physical object, e.g. a book publisher, clothing or toy manufacturer, etc., accesses the unique identifier in step 201 which were generated by a multimedia content provider.

In some embodiments for redeeming the offer, a check for a valid purchase associated with a unique identifier may be made. In some examples, step 202 may be performed which stores associations between the unique identifiers and object identifiers for the objects to be distributed in the promotion. For example, many manufacturers use product codes to track each item they produce, and service providers may use service transaction identifiers to track each service performed. In the case of products as the objects, the product codes may be the object identifiers. In the case of services, the object identifiers may be for the distributed objects with the unique identifiers for the redeemable content items.

The unique redemption identifiers in step 206 are included with the objects to be distributed. In some cases, the one or more processors may also control other computer systems or machinery which format the unique identifiers for integration with electronic or physical objects, which include the unique identifiers with the electronic or physical objects or both. Some examples of including the unique identifiers can include attaching the identifiers, integrating the identifiers as part of the object (e.g. RFID tag in the shoe or jewelry or the cover design of a real world book) or incorporating the identifiers such as including in the data of an electronic content item. In the case of products, the object including the unique identifier may be the product itself. In the case of services, a user may receive an object with the identifier after performing, receiving or paying for a service. For example, the object may be a postcard, a baseball card or a football card with a scratch off area on which a unique identifier is printed. In some cases, for certain products, for example clothing, the promotion operates by providing a separate object including the identifier. In such a case, the user may have bodily contact with the product in the image as well as the object including the identifier in order to redeem the content item.

In step 206, the objects are distributed. For example, physical objects are shipped to stores and warehouses of online retailers, and electronic objects may be shipped in storage media to stores and warehouses or are downloadable, for example from websites of online retailers.

In some examples, when a promoted product or service is purchased, a purchase notification is generated and includes a purchase identifier for accessing a purchase transaction data record which may also include an object identifier of an object involved with the purchase. In optional step 208, responsive to a purchase notification associated with an object, the one or more processors store in the data store an association of the purchase identifier with the offer unique identifier associated with the object in the purchase transaction data. An example of storing an association between two identifiers is storing them in the same data record indexed by one of them. In another example, a pointer is stored in a database record to line the purchase identifier and the unique identifier. Validating a purchase to obtain an object including the offer unique identifier helps improve tracking of the promotion success, but the entity controlling the multimedia application interacts with the databases of licensees.

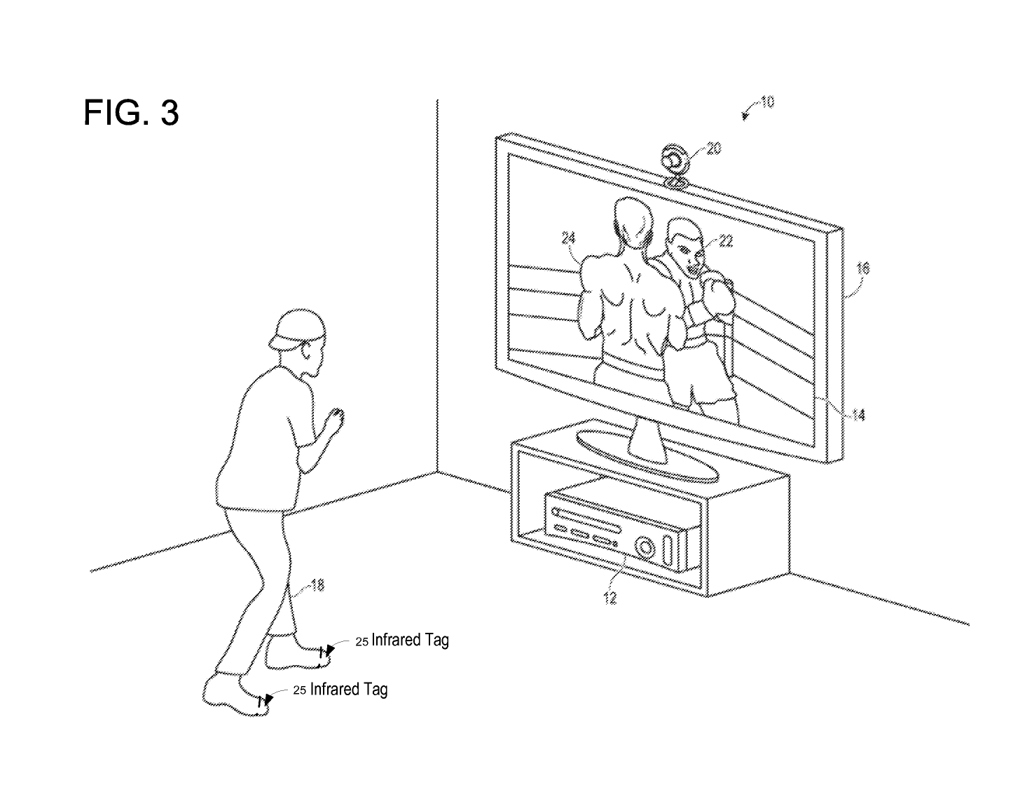

FIG. 3 illustrates an example embodiment of a target recognition, analysis, and tracking system 10 which may be used to recognize and identify a human target such as the user 18 as well as a physical object and a unique identifier included with the object. Embodiments of the target recognition, analysis, and tracking system 10 include a computing environment 12 for executing a game or other multimedia application, and an audiovisual device 16 for providing audio and visual representations from the game or other multimedia application. The system 10 further includes a capture device 20 for capturing images of a user, physical objects and visible unique identifiers. The capture device 20 also captures positions and movements performed by the user in three dimensions (3D), which the computing environment 12 receives, interprets and uses to control the game or other multimedia application.

The capture device 20 captures objects in bodily contact with the user such as a toy or book the user is holding. Furthermore, jewelry and other items the user wears are detected by the capture device 20. An image captured valid unique identifier of a physical object is interpreted to cause redemption of a digital content item by the application.

Embodiments of the computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein. Examples of the computing environment 12 and capture device 20 are explained in greater detail below.

Embodiments of the target recognition, analysis, and tracking system 10 may be connected to an audiovisual device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audiovisual signals associated with the game or other multimedia application. The audiovisual device 16 may receive the audiovisual signals from the computing environment 12 and may then output the game or multimedia application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, a component video cable, a DisplayPort compatible cable or the like.

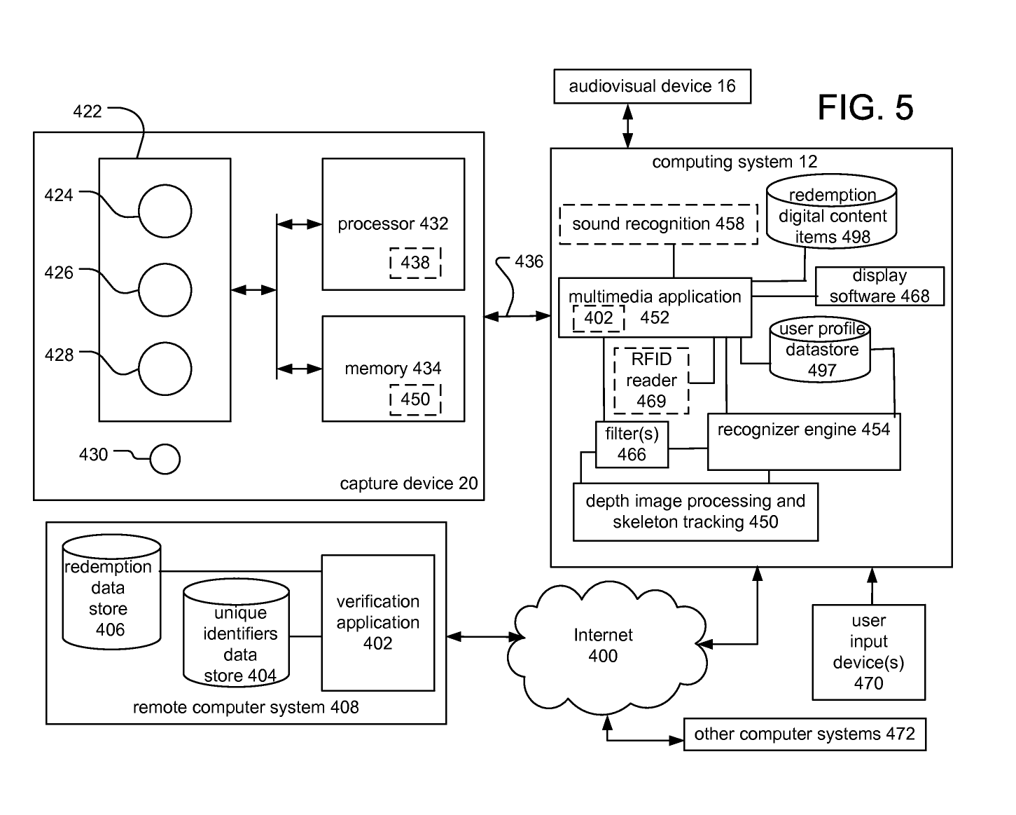

In an example embodiment, the application executing on the computing environment 12 may be a game with real time interaction such as a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, the user 18 may throw a punch in physical space to cause the player avatar 24 to throw a punch in game space. Thus, according to an example embodiment, the capture device 20 captures a 3D representation of the punch in physical space using the technology described herein. One or more processors (see FIG. 5) in the capture device 20 and the computing environment 12 of the target recognition, analysis, and tracking system 10 may be used to recognize and analyze the punch of the user 18 in physical space such that the punch may be interpreted as a gesture or game control of the player avatar 24 in game space and in real time.

In the illustrated example, the user 18 is wearing footwear with infrared tags in the toes. As discussed below, the capture device 20 may be a 3-D camera which uses infrared signals for depth perception. However, in one implementation example, the capture device 20 may also provide an infrared signal for detecting a unique identifier, one example of which detects each of the tags 25 in the shoes and reads data from them including the unique identifier. The user 18 may have bought sneakers or boxing shoes which offered the digital content item of a ‘power punch’ during the boxing game. A power punch may be a punch virtually represented on the display with special effects to indicate a higher level of force behind it in the game.

FIG. 4 illustrates an example of a user in bodily contact with an object including a unique identifier in a field of view of an image capture device. A camera is an image capture device. In this example, a user 19 holds the “Time Travelers A New Order” book having the cover 40a with a unique identifier graphic design 42a. Embodiments of the image capture device 20 may include a zoom lens. After the software executing in the computing environment 12 identifies (e.g. to a confidence level) the user 19 and determines that the object he is holding as a book based on image data from the camera 20, the software can request a more detailed view of the object image data causing the camera to zoom in on the book in this example. The zooming may assist the image of the unique identifier graphic design on the cover is captured in enough detail for verification purposes.

In some embodiments, the user can redeem the offer of content at any point during execution of a multimedia application. Instead or additionally, the application may display on start-up a notice about the offer and how to redeem the offer. The application can instruct the user via the display or through audio to hold, wear or otherwise have bodily contact with the item and adjust his or her distance and angle from the camera in order for the camera to obtain image data with a resolution level sufficient for determining the object and the unique identifier. For example, software performing target recognition may send a message indicating images from the capture device 20 are not clear enough for target recognition of an acceptable confidence level and an indication of direction and distance for target movement within the field of view 17 of the capture device 20. The software may display instructions to the user requesting the indicated direction and distance of movement. For example, the user 19 may be asked to move the book 40a up a number of inches to a few feet closer to the camera to better distinguish the book from the color or pattern of the chair 23.

As mentioned above, in some instances, the unique identifier may be on a physical object separate from the purchased product or service. An example of such a physical object is a scratch off card or tag received when an item of clothing is purchased. In the case of a purchased product, the user may be instructed to wear or hold or otherwise have bodily contact with the product and then to hold up the scratched off card or other item including the unique identifier.

In the figures below, embodiments of hardware and software for implementing the technology are disclosed. Certain modules, data stores and the like are referenced. The particular naming and division of modules, routines, features, attributes, methodologies and other aspects are not mandatory, and the mechanisms that implement the technology or its features may have different names, divisions and/or formats.

FIG. 5 illustrates one embodiment of a system for redeeming an offer of a digital content item. In this embodiment, an image capture device 20, a computing system 12 and a remote computer system 408 are communicatively coupled. The capture device 20 and the computing system 12 may be used in the target recognition, analysis and tracking system 10 to recognize human and non-human targets in a capture area and uniquely identify them and track them in three dimensional space. The system of FIG. 5 is suitable for a natural user interface (NUI) target recognition, analysis and tracking system 10 wherein the user's movements and poses control the action of an application. In other words, the user acts as a controller or user input device, and his or her natural movements may be tracked to an on-screen character to an extent depending on the particular multimedia application, for example, a game application. Other embodiments of the technology may also be implemented in computer systems with cameras or image capture devices which only capture two-dimensional images and do not track natural user movements or poses.

As shown in FIG. 5, the capture device 20 may include an image camera component 422 which may include an IR light component 424, a three-dimensional (3-D) camera 426, and an RGB camera 428 that may be used to capture a depth image of a capture area as well as color, black and white, or grayscale image data of the capture area. Users, objects, and unique identifiers may be identified from this data as explained below.

Different techniques may be used for capturing depth data. For example, in time-of-flight analysis, the IR light component 424 of the capture device 20 may emit an infrared light onto the scene and may then use sensors (not shown) to detect the backscattered light from the surface of one or more targets and objects in the scene using, for example, the 3-D camera 426 and/or the RGB camera 428 to determine a physical distance from the capture device 20 to a particular location on the targets or objects. In other embodiments, a unique identifier on an object may be an infrared tag such as the footwear tag 25 in FIG. 1. The IR component 424 of the capture device 20 may also be used to detect and read a unique identifier on an infrared tag. For example, it may send out a signal which detects and reads the tag, or the tag may give off infrared signals which the IR component 424 detects and formats into a processor or computer readable format. Software 438 executing on the processor 432 of the capture device 20 sends the unique identifier captured by the infrared component 424 to a multimedia application 452 of the computing environment 12.

A unique identifier may be represented in one or more sounds. The capture device 20 may further include a microphone 40 which may be used to receive audio signals generated by the user and objects and which audio signals may include commands to control a multimedia application 452 as well as a unique identifier associated with an object. A user's speech or song may be interpreted to identify commands or data entered such as symbols of a unique identifier, for example letters or numbers, or phrases, lyrics or sentences representing a unique identifier. An object may include a recording or data file of one or more sounds stored in a memory of the object, and which one or more sounds may be played through a speaker on the object under the control of a processor of the object. An example of a sound based unique identifier is speech. Another example is a song, and another is a short musical piece. Part of a sound based identifier may be the recorded voice of the person singing or speaking.

In one embodiment, capture device 20 may further include a processor 32 that may be in operative communication with the image camera component 422. The processor 432 may include a standardized processor, a specialized processor, a microprocessor, or the like that may execute instructions that may include instructions for storing profiles, for detecting targets such as objects and humans using image processing techniques, an example of which is edge detection, receiving the depth image, determining whether a suitable target may be included in the depth image, converting the suitable target into a skeletal representation or model of the target, or any other suitable instruction.

The capture device 20 may further include a memory component 434 that may store the instructions that may be executed by the processor 432, images or frames of images captured by the 3-D camera or RGB camera, or any other suitable information, images, or the like. According to one example, the memory component 434 may include random access memory (RAM), read only memory (ROM), cache, Flash memory, a hard disk, or any other suitable storage component readable by a processor. As shown in FIG. 5, the memory component 434 may be a separate component in communication with the image capture component 422 and the processor 432. In another embodiment, the memory component 434 may be integrated into the processor 432 and/or the image capture component 422. The memory 434 may also include a version of software 450 which may work with software 450 executing in the computing system 12 for performing depth image processing and skeleton model tracking as described further below. In one embodiment, some or all of the components 422, 424, 426, 428, 440, 432 and 434 of the capture device 20 illustrated in FIG. 5 are housed in a single housing.

The capture device 20 may be in communication with the computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. The capture device 20 may provide the depth information, images captured, target edges, and modeling data like a skeletal model that may be generated by the capture device 20, to the computing system 12 via the communication link 436.

The computing environment 12 may then use the skeletal model, depth information, captured images and target edges to, for example, recognize users, objects, unique identifiers and gestures. As used herein, the computing system 12 may refer to a single computing device or to a computing system of more than one computing device. The computing system 12 may include non-computing components as well. The embodiment of the computing environment 12 illustrates some software and data components which may be used to implement one or more embodiments of the technology.

The target recognition, analysis and tracking may be performed by depth image processing and skeleton tracking software 450, which may execute, at least in part on the processor 32 of the image capture device 20 or within the computing environment 12 in conjunction with the recognizer engine 454.

In one embodiment, the edges of each target such as the human target and the non-human targets in the captured scene of the depth image may be determined. Each of the depth values may represent a value such as a length or distance in, for example, centimeters, millimeters, or the like of an object in the captured scene from the capture device 20. According to an example embodiment, the edges may be determined by comparing various depth values associated with, for example, adjacent or nearby pixels of the depth image. If the various depth values being compared are greater than a predetermined edge tolerance, the pixels may define an edge. Edge detection may also be performed on image data captured in two dimensions.

According to another embodiment, predetermined points or areas on the depth image may be flood filled to determine whether the depth image includes a pre-defined target type like a human or object associated with an offer. For example, various depth values of pixels in a selected area or point of the depth image may be compared to determine edges that may define targets. According to one embodiment, the capture device 20 may organize the calculated depth information into “Z layers,” or layers that may be perpendicular to a Z-axis extending from the depth camera along its line of sight. The Z values of the Z layers may be flood filled based on the determined edges. For example, the pixels associated with the determined edges and the pixels of the area within the determined edges may be associated with each other to define a target.

The recognizer engine 454 is associated with a collection of filters 456 each comprising information concerning a user, an object, a unique identifier or a gesture. According to an example embodiment, each of the flood-filled targets, human and non-human, may be matched against a pattern stored as a filter 466 to determine whether and/or which of the targets in the capture area include a human, a physical object including a unique identifier, and the unique identifier if a visually detectable one. The edges of a target may be compared to a shape pattern to identify areas of an image to compare with a stored image of a user's face, physical object or unique identifier at the same resolution or scale. In the case of a human, the shape pattern may include, for example, a machine representation of a predetermined body model associated with a human in various positions or poses such as a typical standing pose with arms to each side. An example of body model is a skeletal model.

The recognizer engine 454 may communicate a zoom command to the image capture device 20 to zoom in on the user, physical object or unique identifier of the physical object for better resolution. A filter for an object, unique identifier or a user may include the stored image data, for example a color photograph previously taken of the object, unique identifier or user which may be used as a more detailed pattern or template for comparison. Stored image data is helpful for recognizing fixed or semi-fixed features. An object and a unique identifier have typically fixed characteristics. Certain human features like facial structure and height are typically fixed, at least for adults, and other features like eye color and hair color may be the same for a long time, (e.g. a few years). For a unique identifier, certain valid colors and shapes may be determined to identify the identifier as a candidate for further verification by the verification application 402 executing in the remote computer system 408.

In an example embodiment, the human target may be isolated and a bitmask of the human target along an X, Y and Z axis may be created to scan for one or more body parts by the depth image processing and skeleton tracking software 450. Measurement values such as length, width, or the like of the body parts may help identify a particular user.

For the identification of the users, the recognizer engine 454 may correlate a user's face from the visual image received from the capture device 20 with a reference visual image which may be stored in a filter 466 to determine the user's identity. The user's skeletal model may also be used for identifying user characteristics. In one embodiment of creating user identification data, users may be asked to identify themselves by standing in front of the computing system 12 so that the capture device 20 may capture depth images and visual images for each user. For example, a user may be asked to stand in front of the capture device 20, turn around, and make various poses. After the computing system 12 obtains data as a basis upon which to identify a user, the user is provided with a user identifier and password identifying the user. More information about identifying users can be found in U.S. patent application Ser. No. 12/696,282, “Visual Based Identity Tracking” and U.S. patent application Ser. No. 12/475,308, “Device for Identifying and Tracking Multiple Humans over Time,” both of which are incorporated herein by reference in their entirety.

In some embodiments, the user's identity may be also determined based on input data from the user like login credentials via one or more user input devices 470. Some examples of user input devices are a pointing device, a game controller, a keyboard, or a biometric sensing system (e.g. fingerprint or iris scan verification system).

In one embodiment, the user's identification information may be stored in a user profile datastore 497 in the computing system 12. The user profile database 497 may include information about the user such as a user identifier and password associated with the user, the user's name and other demographic information related to the user. Examples of such user profile data are the user's age group, gender, geographical location, in one example the user's zip code, games played, the user's statistics for particular games, gamer category (e.g. family, hard-core, casual), other users the user has played with and how often the user has played with each, the user's friends' list (which may be optionally provided by the user), the user's stated preferred activities, features of the user's avatar such as clothing, hair color, eye color and other physical attributes, and other multimedia content viewed by the user on the computing system 12 or other computer system where the user was identified as a viewer. In one embodiment, computing system 12 may automatically track user profile data related to one or more of the users detected by the capture device 20.

Filters are also provided for gestures which as mentioned above are the controls of an application executing in a natural user interface computer system where the user is the controller. A gesture is an action or pose of a user or object which may be detected by the capture device 20 and used to control an application executing in the computing environment 12. A gesture may be dynamic, comprising a motion, such as mimicking throwing a ball or a static pose, such as holding one's crossed forearms in front of his torso. A gesture may also incorporate props, such as by swinging a mock sword. In one embodiment, a gesture filter 466 executes instructions comparing motion tracking data for one or more body parts involved with the gesture with parameters including criteria relating to motion characteristics which define the gesture.

One suitable example of tracking a skeleton using depth image is provided in U.S. patent application Ser. No. 12/603,437, “Pose Tracking Pipeline” filed on Oct. 21, 2009, Craig, et al. (hereinafter referred to as the '437 application), incorporated herein by reference in its entirety. Suitable tracking technologies are also disclosed in the following four U.S. patent applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

More information about embodiments of the recognizer engine 454 for gesture recognition can also be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009. See also U.S. patent application Ser. No. 12/642,589, filed Dec. 18, 2009.

All of the above referenced applications are incorporated by reference herein in their entirety.

The multimedia application 452 communicates with the recognizer engine 454 for receiving data indicating user identifications, object identifications and unique identifiers determined from image data or represented in image data. Additionally, the recognizer engine 454 may notify the multimedia application 452 of gestures of the user, and perhaps, an object (e.g. racket in a tennis game) which are controls or commands to the application.

A multimedia application 452 has access to the user profile data 497 and a data store for one or more redemption digital content items 498. The one or more redemption digital content item data store may include overlays, data identifying content item features like color or texture, dimensions or dimension ranges and other graphical features, or code segments for rendering a content item, e.g. a display object, a skill, a power, etc. Sometimes, the digital content item may relate to updating a physical feature, for example a tattoo or article of clothing, of a user's avatar which the application 452 may identify and retrieve based on the user's profile data 497.

In some embodiments, the unique identifier is received using one or more frequencies (e.g. infrared, radio) outside the visible range. For example, the unique identifier may be a RFID tag including a unique code. The computer system 12 may include an RFID reader 469 which detects and reads the code. The RFID reader 469 notifies the multimedia application 452 of the code which the application 452 processes for verification, and if verified, for redemption as discussed below. In other embodiments, the unique identifier may be one or more sounds the microphone 430 sensed and the processor 432 sends in a digital format which sound recognition software 458 processes for identifying among other things, any sound based unique identifiers which are communicated to the multimedia application 452.

The multimedia application 452 communicates over the Internet 400 with the verification application 402 executing in the remote computer system 408. In some embodiments, for example those where a verification algorithm is applied to determine if an identifier is valid, the multimedia application 452 may include verification software 402. In this embodiment, the remote verification application 402 has access to a unique identifiers data store 404 which includes valid unique identifiers and associated data. These valid unique identifiers may be compared with received identifiers for verifying the validity of the received identifiers. The verification application 402 also has access to a redemption data store 406 which can aggregate data based on the identifiers received and validated and other information provided by the multimedia application 452 like user profile data. As discussed in other examples below, verifying software 402 whether embodied in a remote verification application 402 or the multimedia application 452 may also communicate with other computer systems 472 accessible via the Internet 400 to obtain other data relevant to the redemption of content items.

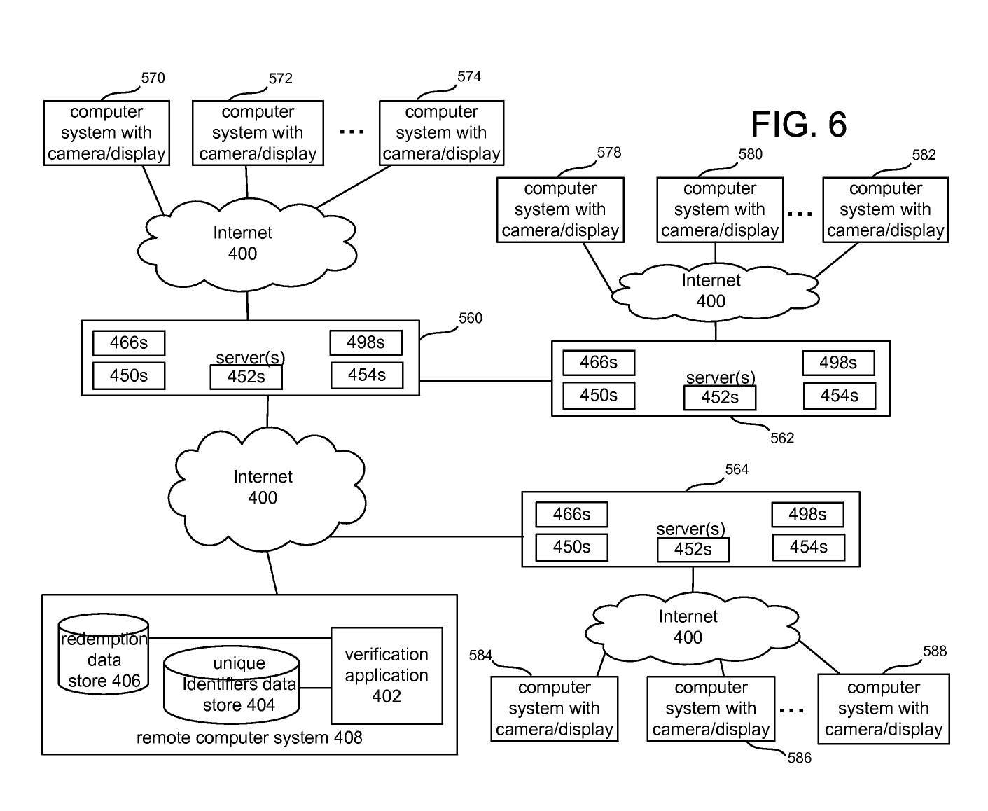

FIG. 6 illustrates another embodiment of a system for redeeming an offer of a digital content item within a network of computers. This embodiment illustrates some of the processing may be performed by one or more servers 560, 562, and 564 connected via the Internet 400 which may have more powerful computer systems. In this example, the servers execute instantiations, typically as processes, of the multimedia application 452, the depth image processing and skeleton tracking application 450, the recognizer engine 454, the filters 466, which can include instructions, store data or both, and the accompanying data stores of the redemption digital content items 498. A user may interact with a local computer system 570, 572, 574, 578, 580, 582, 584, 586, 588 which communicates data, including image data from a camera to the servers and receives data, including multimedia content, including redeemed digital content items for valid identifiers, from the servers 460, 462, 464 for the local display. The servers in this example also interact with one or more instantiations of the verification application 402 in providing data including received identifiers for verification and receiving back verification or validity indication messages.

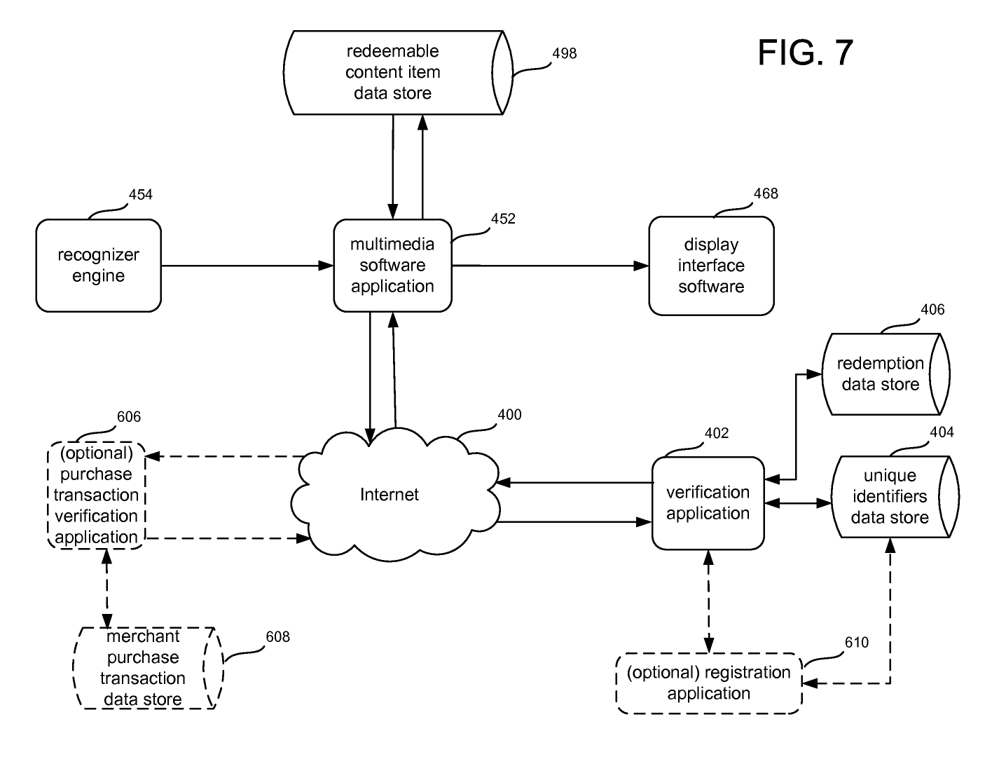

FIG. 7 illustrates an embodiment of a system from a software perspective for redeeming an offer of a digital content item. In this example, a multimedia application includes software providing the digital content item. A multimedia application may be a game, video, movie, audio application, etc. It may also be an application which interacts with a multimedia application like a menu service providing a graphical user interface. For example, a gaming service is a multimedia application. The gaming service provides a graphical user interface which allows a user to update his or her avatar, update his or her profile, select which other multimedia application to execute, and communicate using audio and visual data with friends through functions like chat. The gaming service may also perform target recognition, analysis and tracking of a user for identification purposes and to receive instructions. The gaming service user interface may provide a redemption software application or part of the software for the redemption process for redeeming a digital content item. Particularly for content items which may be used across multimedia applications, for example an item related to an avatar or other user characteristic which is used across applications, it may be more efficient for the gaming service to provides a redemption interface. In other examples, each application provides for redemption of content items available within its execution.

The multimedia application 452 has access to the redeemable content item data store 498. The multimedia application 452 receives from the recognizer engine 454 identifications of physical objects, unique identifiers, users and gestures which may be received in image data. The application 452 may index into a data record for a content item using a verified or valid unique identifier. In some examples, the content item may be an overlay or other graphical or image data to be formatted by the application 452 for rendering by the display interface software 468 on the audiovisual display 16. The graphical or image data may be for example a tattoo to be applied to a user's avatar indicating the user has possession or ownership of a strategy guide related to a game. Other examples may be instructions for displaying the user's virtual representation, e.g. game character, perform a special skill like being able to jump 20 feet responsive to a gesture from the user, and data identifying the filter for the gesture. A graphic overlay and instructions for displaying a weapon as the content item may be stored. Other items may not be graphical per se but may be stored as data indicating game points or virtual money which can be used in a game. The content item may be a video to be played or a song in other multimedia applications.

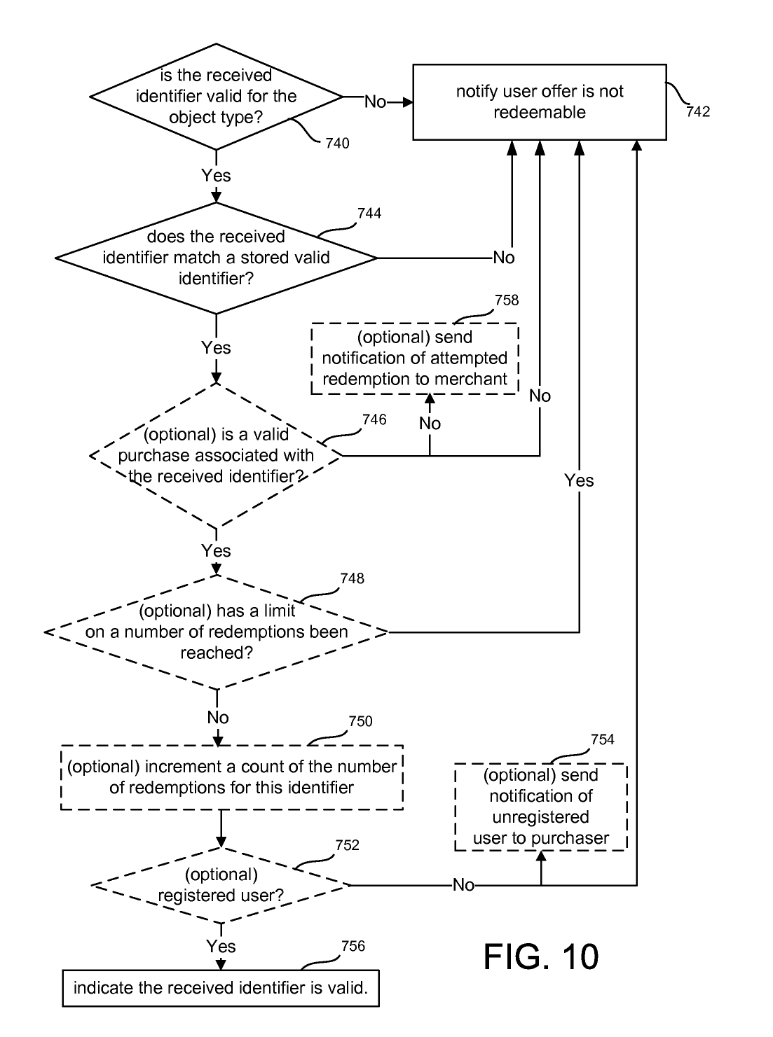

In this embodiment, the multimedia application communicates the received unique identifier, a descriptive identifier for the object, and in some examples a user identifier and/or user profile data over the Internet 400 to a remote verification application 402 executing in a remote computer system 408. The verification application 402 has access to a unique identifiers data store 404 which stores data from which the validity of a received identifier may be determined. An optional registration application 610 communicates to the verification application when it has updated a unique identifier data set to identify one or more registered users with the identifier. The verification application 402 may also optionally communicate with a purchase transaction verification application 606. The purchase transaction verification application 606 has access to a merchant purchase transaction data store 608 which stores purchase transaction data. Some examples of purchase transaction data are an identity of a purchaser, an identifier for the object purchased like a merchant or manufacturer's identification code for the object, and the amount, time, date, and place of purchase. As discussed in the examples of FIG. 10, data from or generated by these other applications 606 and 610 may form a basis for verifying the validity of a unique identifier. The verification application 402 sends a notification like a message indicating whether the unique identifier is valid or not to the multimedia application 452.

The verification application 402 may also update redemption data for verified unique identifiers. Some examples of redemption data are demographic data for users who redeemed unique identifiers associated with certain types of content items, quantity of content item redemption requests, and how often the content item was used based on data updates from the multimedia application 452. Other examples may include price of an object including the unique identifier, and time, place, date and location of sales.

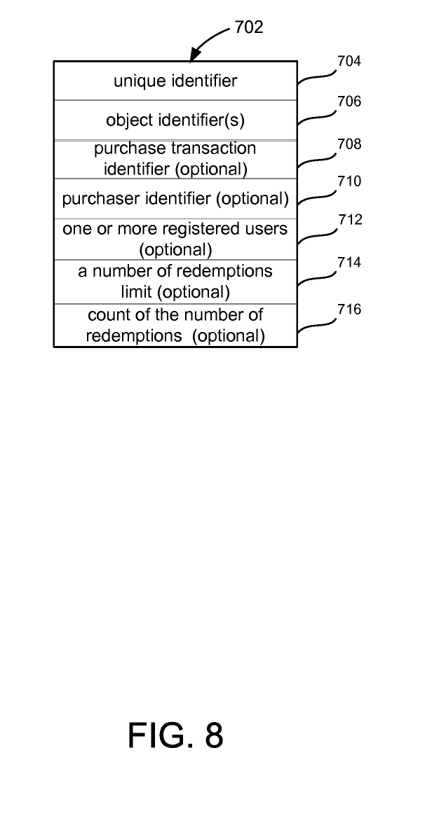

FIG. 8 illustrates an example of a data set 702 for a unique identifier as may be stored in data store 404. The data set 702 comprises a valid unique identifier 704 and one or more object identifiers 706. For real world physical objects, the object identifier may be a type of object, or a template for an object type. In other examples, it may be a unique identifying code for the physical object. An example of a unique identifying code is a manufacturer's code. For electronic content items, there may be an object identifier for the electronic content item itself as well as object types and/or object type templates for physical objects which can display or output the electronic content item and its unique identifier. An example of a template is an image template like an object bitmask or edge outline for recognizing a target as the physical object.

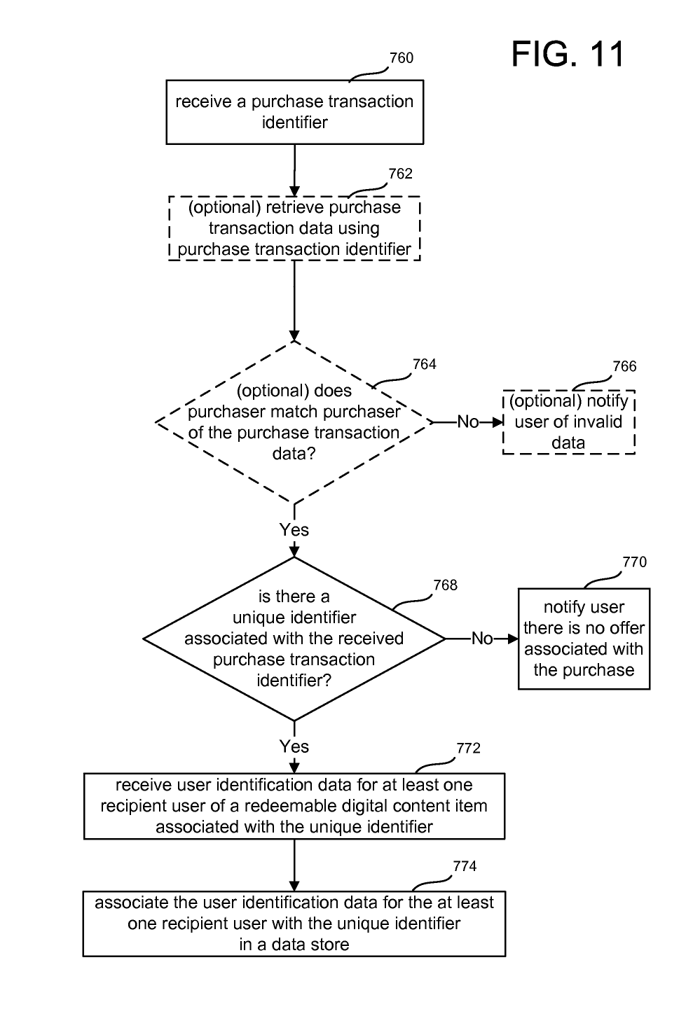

As per the discussion of FIGS. 10-11, a number of other data fields in the data set may include those related to validity criteria. Some of these example data fields are shown as optional data fields: a purchase transaction identifier 708, a purchaser identifier 710, one or more registered users 712, a number of redemptions limit 714 and a count of the number of redemptions 716.

The method embodiments of FIGS. 7 through 11 are discussed for illustrative purposes in the context of the system embodiments illustrated in the previous figures. The method embodiments may operate within other system embodiments.

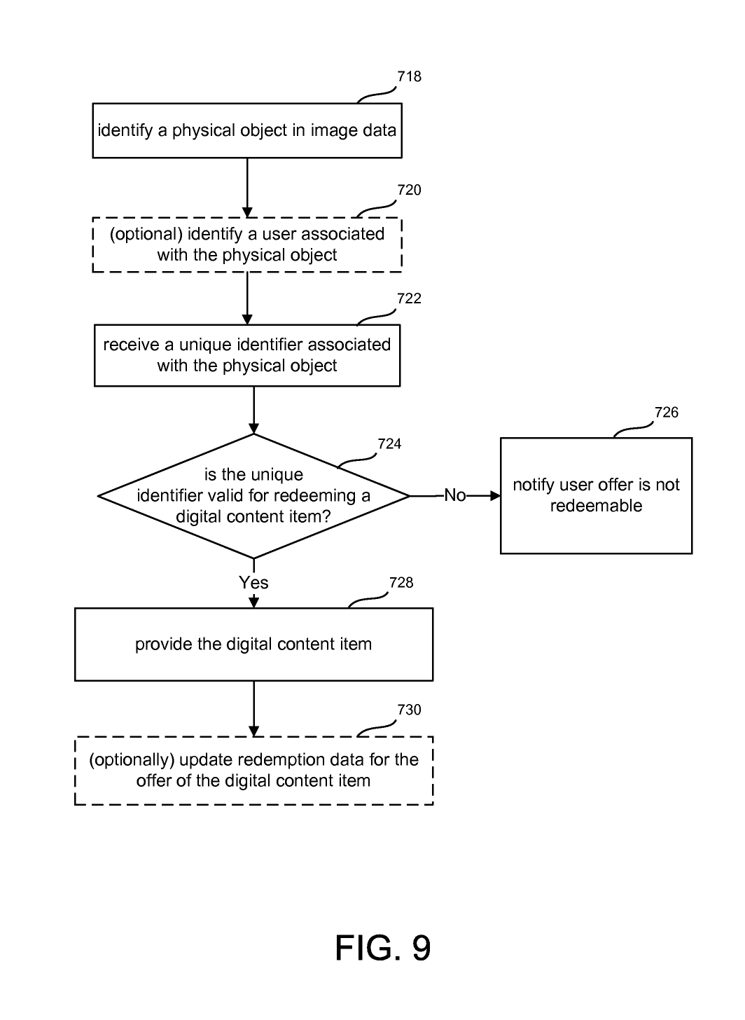

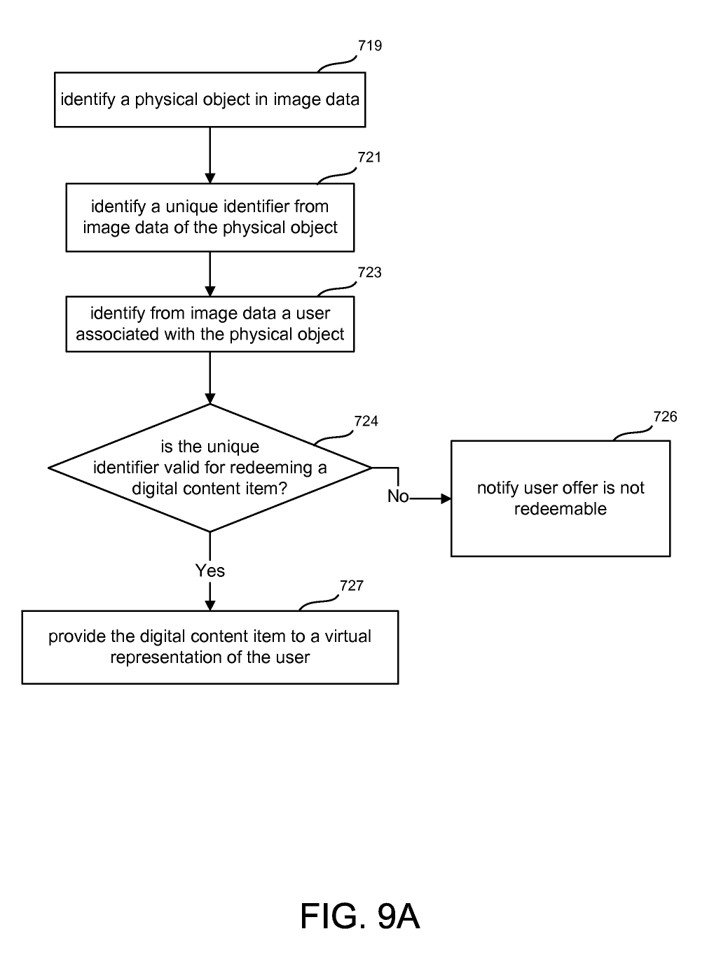

FIG. 9 is a flowchart of an embodiment of a method for redeeming an offer of a digital content item for use. In step 718, the recognizer engine 454 identifies a physical object in image data. Optionally, in step 720, the engine 454 identifies a user associated with the physical object. In some embodiments, the user associated with the physical object is identified from image data. For example, the target recognition, analysis, and tracking system of FIGS. 3 through 5A, or a notebook computer with a camera, e.g. a web cam, an image capture device 20 may capture an image of the user holding, wearing or otherwise having bodily contact with the physical object so the association between the user and physical object is body contact. In other systems, such as a mobile phone with a camera, it may be more convenient for a user to take a photo of the physical object and during a time period either shortly before or shortly after, provide user identification data. Examples of user identification data may be login credentials, biometric data like a fingerprint or image data like a photograph of himself. For example, image data or biometric data of the user may be received within a time period (e.g. one minute) of the image data of the physical object.

Software for providing a digital content item, for example, a multimedia application, receives a unique identifier associated with the physical object in step 722. As discussed in the examples above, the identifier may have been identified from image data by the recognizer engine 454 applying a filter or pattern to incoming image data from the image capture device 20. As also shown in the examples, the unique identifier may be embodied in an RFID tag which the RFID reader 469 reads and converts to a processor readable format for the multimedia application to process Infrared signals from the 3D image capture device 20 may also be used to read data from an infrared tag 25 which the processor 432 formats including the unique identifier in a processor readable format for the multimedia application.

The multimedia application 452 performs processing in step 724 to verify whether the identifier is a valid unique identifier for redeeming a digital content item. In some examples, the multimedia application may access a local data store of valid unique identifiers and determine if a match is available. In other examples, the multimedia application sends the received identifier to a verification application 602 residing in a remote computer system with access to a unique identifiers data store. For example, this second option may be employed when there are millions of unique identifiers distributed with products or services or both. In some examples, part of the verification of graphic design identifiers is to apply a formula to characteristics of the graphic design to convert the graphic design to a number, letter sequence or alphanumeric sequence which is the basis of comparison with valid unique identifiers or the basis for application of a verification algorithm.

In other examples, the multimedia application 452 or the verification application 602 may apply a verification algorithm to the received identifier to verify whether it is valid or not. For example, the received identifier may be used as a public key by the verifying software in performing an asymmetric key based algorithm to determine whether it produces the same nonce as a private key stored in memory accessible by the verifying software.

Responsive to the unique identifier being invalid, the multimedia application notifies the user the offer is not redeemable. For example, the notification of an invalid unique identifier may be indicated in an audio output, a displayed notice or an audiovisual output of the audiovisual display device 16. Responsive to the unique identifier being verified as valid, the multimedia application provides the digital content item in step 728. For example, if the digital content item is an interactive sequence like a game add-on, software like a game application executes the code of the game add-on. If the digital content item is a song, software like a multimedia application causes the song to be played. In a similar example, a multimedia application plays video content downloaded as the digital content item or accessed by a key or other access identifier as the digital content item.

In some examples, the digital content item is associated with the user associated with the physical object so that only that user may access the digital content item for the current session or for future sessions as well. An example of such an item is a tattoo, article of clothing, jewelry, a weapon, or sporting good or other personal item for an avatar. In other examples, the digital content item is available to all users playing. For example, an item of a new weapon in a game may be purchased in a “sanctuary” area of the game by any user playing. In other examples, the digital content item may be something like a special effect which occurs on an action regardless of which game character performs the action.

Optionally, the verifying software of either the multimedia application 452 or the verification application 602 or both in step 730 updates redemption data for the offer of the digital content item. Some examples of redemption data are the total number of unique identifiers that have been redeemed, the quantities of different types of digital content items that have been redeemed, and other logistic data like locations of redemptions, applications for which items were redeemed, and within what time period of purchase of a game or other multimedia application was the item redeemed.

FIG. 9A is a flowchart of an example of the method embodiment of FIG. 9. In this example, the recognizer engine 454 in step 719 identifies a physical object in image data, identifies a unique identifier from image data of the physical object in step 721, and identifies from image data a user associated with the physical object in step 723. As shown in the examples of FIG. 1, the unique identifier may form part of the physical object. For example, there was the two dimensional barcode of the seven point star on the T-Shirt 32, and the hour glass graphic design versions 42a, 42b of different versions 40a, 40b of a cover of a book. The unique identifier may be part of a digital or electronic content item purchased and displayable by a computing device physical object.

In other examples, the unique identifier may be on a card or other object separate from the purchased or distributed object. For example, a scratch off card may be given separately at the cash register when purchasing a physical item like an article of clothing, a book, a compact-disc or DVD, etc. The user may hold up to a camera communicatively coupled to the computer system executing the multimedia application, e.g. image capture device 20, the scratched off card or other item having the unique identifier in addition to holding or wearing the item or within a time period of doing so.

Based on the identified physical object, the unique identifier and identified user data, the method continues with step 724. If the identifier is not a valid unique identifier, a notification that the offer is not redeemable is output in step 726. Otherwise, the digital content item is provided to a virtual representation of the user in step 727.

FIG. 10 is a flowchart illustrating an embodiment of a method and criteria examples for verifying a unique identifier. In step 740, the verification application 402 for example determines whether the received unique identifier is valid for the physical object. For example, if the unique identifier is associated with an electronic content item, the unique identifier may be valid for a physical object type of a computing device but not a T-shirt. Similarly, an RFID tag including a unique identifier for a baseball cap may not be valid if it has been removed and attached to a T-shirt.

If the unique identifier is invalid for the object type, in step 742, the user is notified the offer is not redeemable. For example, the multimedia application 452 receives a message from the verification application 402 that the unique identifier was invalid due to an invalid object type, and the multimedia application 452 displays a message on the audiovisual device 16 display 14 that the unique identifier is invalid for the physical object associated with the unique identifier.

Responsive to the object type being valid for the unique identifier, in step 744 a comparison of the received identifier with stored valid identifiers is performed to determine if the received identifier does match a stored valid identifier. As discussed above, in other examples, a verification algorithm or calculation may be performed based on the received identifier to determine its validity. Responsive to invalidity being indicated, a notification message in step 742 indicating the offer is not redeemable is output on a computer device to notify the user. Before discussing the optional criteria examples, if no further invalidity criteria is applied, the verification application 402 indicates the received unique identifier is valid.

FIG. 10 illustrates other examples of validity criteria which may be tested. In step 746, a determination may be made whether there is a valid purchase associated with the received identifier. For example, in the embodiment of FIG. 7, the verification application 402 may receive from a purchase transaction verification application updates of purchase transaction identifiers associated with identifiers for purchased objects including the unique identifiers. This criteria depends on how quickly a merchant's purchase transaction data store is updated, whether the verifying software has access to the merchant's purchase transaction data store, or how often the purchase transaction data is forwarded, and whether any data reformatting is to be done before processing by the verifying software, e.g. the multimedia application 452, the verification application 402 or both.

In one embodiment, the verifying software can send a request with the unique identifier or an object identifier to one or more merchant's purchase transaction verification applications to receive a valid purchase identifier as an indicator that the received unique identifier is associated with a valid purchase. If so the data set for the unique identifier in the unique identifier data store can be updated with a purchase identifier. Either a message indicating the unique identifier is valid is sent in step 756 or more validity criteria are tested. If not, step 742 may be repeated by notifying the user via a message outputted via a display or audio device or audiovisual device that the offer is not redeemable due to lack of a valid purchase. Additionally, the verification software 402 sends in step 758 a message to the purchase transaction verification application notifying the merchant that a user has attempted to redeem the digital content item using the identifier associated with an object for which there is not a valid transaction. In some examples, identification data for the user may be provided to the merchant. In this way, if an object is lost or stolen, who currently has it may be determined.

In step 748, another optional criteria of a limit on a number of redemptions being reached is determined. If yes, step 742 may be repeated by notifying the user via a message outputted by a computing device to a display or audio device or audiovisual device that the offer is not redeemable due to the number of redemptions being reached. If the number of redemptions has not been reached, in step 750, a count of the number of redemptions for this unique identifier is incremented. If no other criteria to be evaluated, step 756 may be performed. Another example of a criteria is a time period limit. For example, the offer ends by a calendar date.

In another example of a validity criteria, whether the identified user is a registered user for the redeemable digital content item is determined in step 752. A purchaser may register the digital content to be given to a particular user. For example, a person buys as a gift a book related to a game application with an offer of a weapon or a number of weapons to be used in the game. The purchaser may go online to a website associated with the game and register each of her nieces and nephews in the same household to be able to use the weapon or one of the offered weapons in the game. An example of registering recipient users is illustrated in FIG. 11. The data set for the unique identifier, as indicated in FIG. 8, may be updated to include the names of the recipient users as registered users. If the user is the registered user, a message indicating the unique identifier is valid is sent in step 756. Of course, other validity criteria may also be tested.

If the registered user field has been filled, and the identified user is not a registered user, not only may step 742 be performed with outputting a message to a display, audio device or audiovisual display that the offer is not redeemable, the verification software 402 sends in step 754 a message to a computer location accessible by the purchaser, e.g. an e-mail message to an e-mail account, notifying the purchaser that an unregistered user has attempted to redeem the digital content item. In some examples, identification data for the unregistered user may be provided to the purchaser. In this way, if an object is lost or stolen, who currently has it may be determined.

FIG. 11 is a flowchart illustrating an embodiment of a method for registering a user for receiving the digital content item associated with a unique identifier. A purchaser may go to a website or other software interface which allows him or her to register a user to receive a digital content item redeemable by a unique identifier associated with a purchased or distributed object. Software executing on a processor like registration application 610 accessible via the website or other software interface receives in step 760 a purchase transaction identifier. For example, the user may enter the purchase transaction identifier from a receipt to the website using an electronic transfer from an electronic receipt or using a user input device like a keyboard or touchscreen. Outside of the optional steps 762, 764, and 766, the registration application 610 determines whether there is a unique identifier associated with the received purchase transaction identifier in step 768. If not, in step 770, the user interacting with the website or other software interface is notified via a display or audio output that there is no offer associated with the purchase.

If there is a unique identifier associated with the purchase transaction identifier, the registration application 610 receives user identification data for at least one recipient user of the redeemable digital content item associated with the unique identifier. For example, the purchaser enters user identification data for each of her nieces and nephews at the game website. The registration application 610 in step 774 associates the user identification data for the at least one recipient user with the unique identifier in a data store. For example, the registration application 610 stores the user identification data of the at least one recipient as a registered user data field in the data set for the associated unique identifier. A message may also be sent to the verification application 402 that a registered user field of the unique identifier has been updated.

The optional steps 762, 764, and 766 may be used to further prevent the unauthorized redemption of the digital content items. In optional step 762, the registration application 610 by itself or via the verification application 402 retrieves purchase transaction data using the purchase transaction identifier, and determines in step 764 whether the purchaser identified by user input data matches the purchaser identified in the purchase transaction data. For example, the user doing the registration of recipient users may be asked to enter his or her name, and the registration application 610 checks the name on the credit card or other electronic payment identifier used to purchase the object. For cash transactions, a name check may not be an option unless the person used a loyalty card. If the purchaser does not match data entered for the purchaser field, in step 766, a notification is output by the website, like a displayed notice, that invalid data has been entered. If there is a match or it was an untrackable cash transaction, the process continues with the determination at step 768.

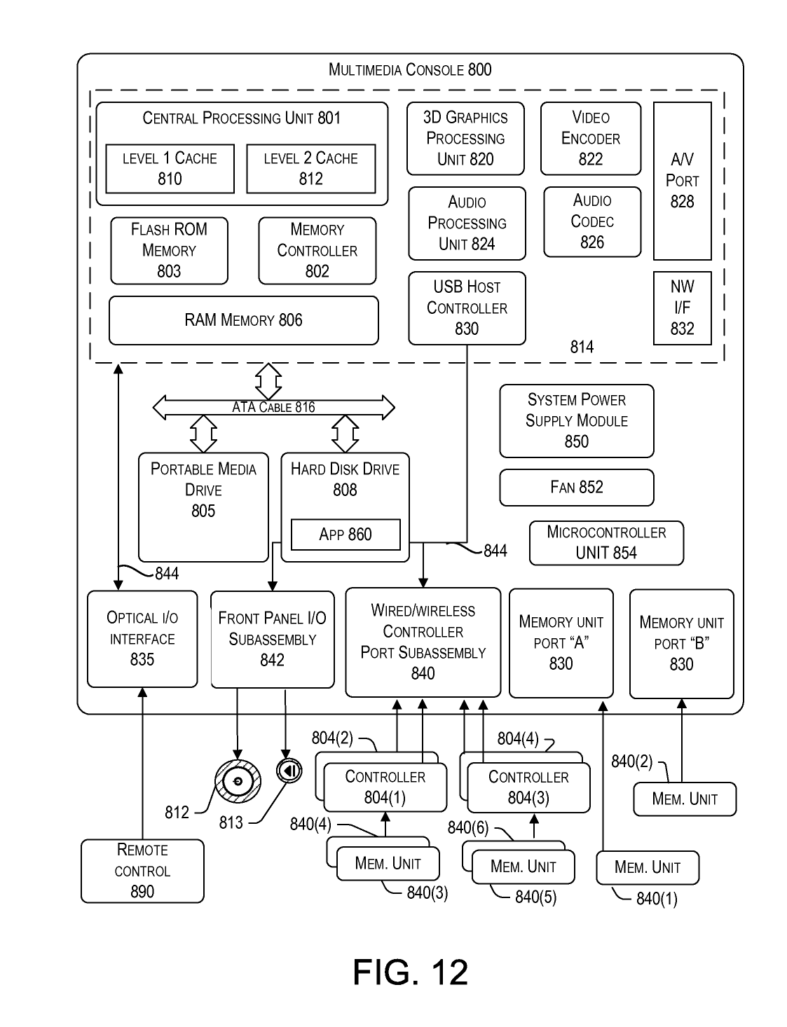

FIG. 12 illustrates an example of a computing system that may be used to implement one or more embodiments of the technology. In this embodiment, the computing system is a multimedia console 800, such as a gaming console. As shown in FIG. 12, the multimedia console 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 806. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is configured as a flash ROM that is connected to memory controller 802 via a PCI bus and a ROM bus (neither of which are shown). RAM 806 is configured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an A/V (audio/video) port 828 for transmission to a television or other display. In the illustrated implementation, video and audio processing components 820-828 are mounted on module 214.

FIG. 12 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 12 console 800 includes a controller support subassembly 840 for supporting four controllers 804(1)-804(4). The controller support subassembly 840 includes any hardware and software components needed to support wired and wireless operation with an external control device, such as for example, a media and game controller. A front panel I/O subassembly 842 supports the multiple functionalities of power button 812, the eject button 813, as well as any LEDs (light emitting diodes) or other indicators exposed on the outer surface of console 802. Subassemblies 840 and 842 are in communication with module 814 via one or more cable assemblies 844. In other implementations, console 800 can include additional controller subassemblies. The illustrated implementation also shows an optical I/O interface 835 that is configured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be configured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into console 800 or a controller, MU 840 can be accessed by memory controller 802. A system power supply module 850 provides power to the components of gaming system 800. A fan 852 cools the circuitry within console 800. A microcontroller unit 854 is also provided.

An application 860 comprising machine instructions is stored on hard disk drive 808. When console 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Gaming and media system 800 may be operated as a standalone system by simply connecting the system to monitor 16 (FIG. 3), a television, a video projector, or other display device. In this standalone mode, gaming and media system 800 enables one or more players to play games, or enjoy digital media, e.g., by watching movies, or listening to music. However, with the integration of broadband connectivity made available through network interface 832, gaming and media system 800 may further be operated as a participant in a larger network gaming community.

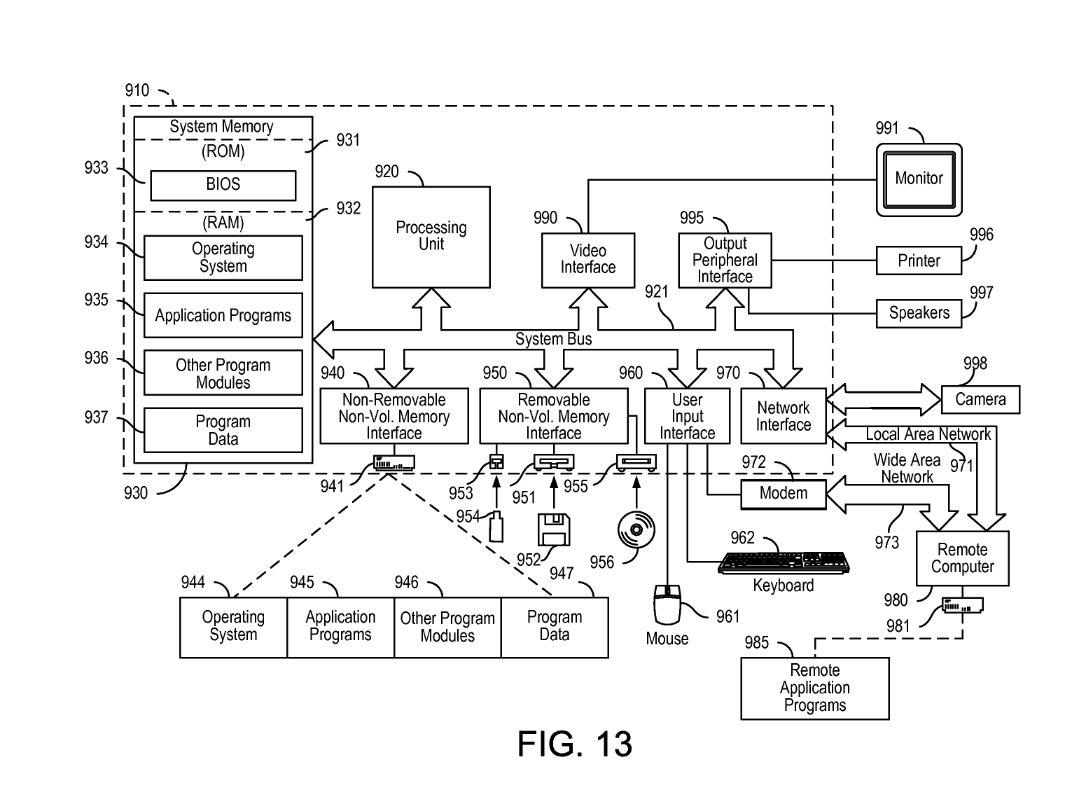

FIG. 13 illustrates an example of a general purpose computing system which may be used to implement one or more computer systems used in implementing one or more embodiments of the technology. With reference to FIG. 13, an exemplary system for implementing embodiments of the disclosed technology includes a general purpose computing system in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 13 illustrates operating system 934, application programs 935, other program modules 936, and program data 937.

The computer 910 may also include other removable/non-removable, volatile/nonvolatile computer storage media. By way of example only, FIG. 13 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Additionally, FIG. 13 illustrates a removable media drive 953 that reads or writes to a removable memory stick 954 or removable memory card 954. In some examples, the memory card may be a flash memory card or stick. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 13, provide storage of computer readable instructions, data structures, program modules and other data for the computer 910. In FIG. 13, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 20 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 13. The logical connections depicted in FIG. 13 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 13 illustrates remote application programs 985 as residing on memory device 981. Another example of a networked device is a camera 998 for providing image data to the computer system 910. It will be appreciated that the network connections shown are exemplary and other means of establishing a communications link between the computers may be used.

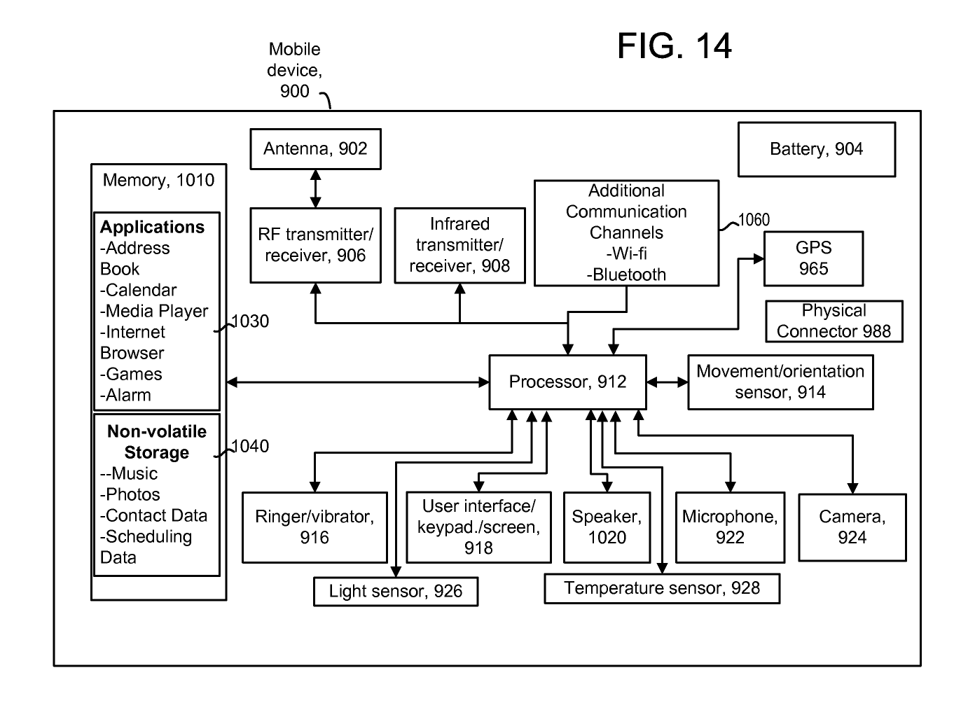

FIG. 14 depicts an example block diagram of a mobile device in which embodiments of the technology may operate. Exemplary electronic circuitry of a typical mobile phone is depicted. The phone 900 includes one or more microprocessors 912, and memory 1010 (e.g., non-volatile memory such as ROM and volatile memory such as RAM) which stores processor-readable code which is executed by one or more processors of the control processor 912 to implement the functionality described herein.

Mobile device 900 may include, for example, processors 912, memory 1010 including applications and non-volatile storage. The processor 912 can implement communications, as well as any number of applications, including the interaction applications discussed herein. Memory 1010 can be any variety of memory storage media types, including non-volatile and volatile memory. A device operating system handles the different operations of the mobile device 900 and may contain user interfaces for operations, such as placing and receiving phone calls, text messaging, checking voicemail, and the like. The applications 1030 can be any assortment of programs, such as a camera application for photos and/or videos, an address book, a calendar application, a media player, an internet browser, games, other multimedia applications, an alarm application, other third party applications, the interaction application discussed herein, and the like. The non-volatile storage component 1040 in memory 1010 contains data such as web caches, music, photos, contact data, scheduling data, and other files.

The processor 912 also communicates with RF transmit/receive circuitry 906 which in turn is coupled to an antenna 902, with an infrared transmitted/receiver 908, with any additional communication channels 1060 like Wi-Fi or Bluetooth, and with a movement/orientation sensor 914 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 912 further communicates with a ringer/vibrator 916, a user interface keypad/screen, biometric sensor system 918, a speaker 1020, a microphone 922, a camera 924, a light sensor 926 and a temperature sensor 928.

The processor 912 controls transmission and reception of wireless signals. During a transmission mode, the processor 912 provides a voice signal from microphone 922, or other data signal, to the RF transmit/receive circuitry 906. The transmit/receive circuitry 906 transmits the signal to a remote station (e.g., a fixed station, operator, other cellular phones, etc.) for communication through the antenna 902. The ringer/vibrator 916 is used to signal an incoming call, text message, calendar reminder, alarm clock reminder, or other notification to the user. During a receiving mode, the transmit/receive circuitry 906 receives a voice or other data signal from a remote station through the antenna 902. A received voice signal is provided to the speaker 1020 while other received data signals are also processed appropriately.

Additionally, a physical connector 988 can be used to connect the mobile device 900 to an external power source, such as an AC adapter or powered docking station. The physical connector 988 can also be used as a data connection to a computing device. The data connection allows for operations such as synchronizing mobile device data with the computing data on another device.

A GPS receiver 965 utilizing satellite-based radio navigation to relay the position of the user applications is enabled for such service.

The example computer systems illustrated in the figures include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

The technology may be embodied in other specific forms without departing from the spirit or essential characteristics thereof. Likewise, the particular naming and division of applications, modules, routines, features, attributes, methodologies and other aspects are not mandatory, and the mechanisms that implement the technology or its features may have different names, divisions and/or formats. Furthermore, as will be apparent to one of ordinary skill in the relevant art, the applications, modules, routines, features, attributes, methodologies and other aspects of the embodiments disclosed can be implemented as software, hardware, firmware or any combination of the three. Of course, wherever a component, an example of which is an application, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of programming.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of redeeming an offer of a digital content item comprising:
identifying a physical object in image data;
receiving a unique identifier associated with the physical object;
verifying whether the unique identifier is valid for redeeming the digital content item; and
responsive to the unique identifier being valid, executing software providing the digital content item.

2. The method of claim 1 further comprises identifying a user associated with the physical object.

3. The method of claim 2 wherein identifying the user associated with
the physical object further comprises:
identifying the user associated with the physical object from image data by at least one of:
identifying the user in bodily contact with the physical object from image data; or
identifying the user in image data received within a time period of
the image data of the physical object.

4. The method of claim 1 wherein executing software providing the digital content item comprises at least one of:
displaying the digital content item;
playing video of the digital content item;
playing audio of the digital content item; or
executing code of the digital content item.

5. The method of claim 1, wherein:
receiving the unique identifier associated with the physical object comprises
identifying the unique identifier from image data of the physical object.

6. The method of claim 1, wherein:
verifying whether the unique identifier associated with the physical object is
valid for redeeming the digital content item further comprises:
determining whether the unique identifier is valid for the physical object in the image data.

7. The method of claim 1, wherein:
verifying whether the unique identifier associated with the physical object is valid for redeeming the digital content item further comprises:
determining whether the physical object is correlated with a valid purchase transaction for the physical object.

8. The method of claim 1 further comprising:
the unique identifier is associated with an electronic content item which may be formatted for output by the physical object which is a computing device.

9. The method of claim 8, wherein:
verifying whether the unique identifier associated with the physical object is valid for redeeming the digital content item further comprises:
determining whether the electronic content item is correlated with a valid purchase transaction for the electronic content item.

10. The method of claim 1 wherein the physical object comprises one
or more of the following:
a computing device;
a book;
a removable storage media;
an article of clothing;
an article of footwear;
a sporting good;
packaging;
a toy;
a card;
a key ring;
a paper product; or
an article of jewelry.

11. The method of claim 1 wherein the digital content item comprises
one or more of the following:
a machine;
a tool;
a weapon;
a tattoo;
a special effect;
a skill;
a power;
a character;
a pet;
a vehicle;
an outfit;
downloadable content;
a game add-on;
game points;
virtual money;
an interactive sequence;
a video;
audio data;
a game hint; or
a map.

12. The method of claim 2 further comprising:
checking whether the identified user associated with the physical object is a registered user for redeeming the digital content item for the unique identifier associated with the physical object; and
responsive to the user being unregistered, sending a message indicating user identification data for the unregistered user to a purchaser identified in a purchased transaction data set associated in memory with the unique identifier.

13. A computer-implemented system for redeeming an offer of a digital content item comprising:
an image capture device for capturing image data of a physical object including a unique identifier and image data of a user associated with the physical object;
one or more processors being in communication with the image capture device for receiving the image data of the physical object and for identifying the user associated with the physical object from the image data;
the one or more processors receiving and verifying the unique identifier; and
responsive to verification of the unique identifier, the one or more processors executing software providing the digital content item to a virtual representation associated with the identified user.

14. The system of claim 13 wherein:
the one or more processors for identifying the user associated with the physical object from the image data further comprises at least one of:
identifying the user in bodily contact with the physical object from image data; or
identifying the user in image data received within a time period of the image data of the physical object.

15. The system of claim 13 further comprising:
a data store accessible to the one or more processors; and
responsive to verification of the unique identifier, the one or more processors updating redemption data for the offer of the digital content item in the accessible data store.

16. The system of claim 13 further comprising a reader communicatively coupled to the one or more processors for receiving the unique identifier using one or more frequencies outside the visible range.

17. The system of claim 13 wherein the unique identifier is a graphic design, and the one or more processors receives the unique identifier as image data.

18. The system of claim 17 wherein the one or more processors verifying the unique identifier further comprises comparing the graphic design against one or more stored valid graphic designs based on one or more characteristics of the graphic design comprising at least one of:
a color pattern;
a size;
an orientation;
a shape;
one or more symbols;
an arrangement of one or more symbols; and
one or more sounds.

19. One or more processor-readable storage media having instructions encoded thereon which instructions cause one or more processors to execute a method for redeeming an offer of a digital content item, the method comprising:
identifying a physical object in image data;
receiving a unique identifier associated with the physical object;
verifying whether the unique identifier is valid for redeeming the digital content item;
responsive to the unique identifier being valid, executing software providing the digital content item; and
updating redemption data for the offer of the digital content item.

20. The one or more processor-readable storage media of claim 19 verifying whether the unique identifier is valid for redeeming the digital content item further comprises:
verifying whether the unique identifier is valid for redeeming the digital content item by performing an asymmetric key based algorithm using the unique identifier as a public key.
